(19) United States
(12) Patent Application Publication
(10) Pub. No.: US 2004/0108980 A1
(43) Pub. Date: Jun. 10, 2004

(54) Display element, display panel, and display apparatus

(75) Inventors: Masatoshi Yonekubo, Hara-mura (JP); Taisuke Yamauchi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 10/694,987

(22) Filed: Oct. 29, 2003

(30) Foreign Application Priority Data
Nov. 11, 2002 (JP) 2002-326909

(51) Int. Cl. G09G 3/30

(52) U.S. Cl. 345/76

(57) ABSTRACT

The invention provides a display panel having high light-extraction efficiency which can be easily produced. The present invention provides a display panel including an emission layer having a light-emitting layer and a transparent member (transmission layer) having recesses, an inclined surface of the recesses acting as a total reflection surface to reflect part of light radiated from the light-emitting layer. The display panel changes the optical path by total reflection, thus having no light-absorption loss and having high light-extraction efficiency. Since there is no need to deposit a reflecting film, it is easy to produce. Thus, a high-intensity display panel can be provided at low cost.

### BACKGROUND OF THE INVENTION

1. Field of Invention

The present invention relates to a display panel having a self-luminous device, such as an organic electro-luminescent (organic EL) device, and to a method for producing the same.

2. Description of Related Art

Display panels having an organic EL device or a plasma display panel (PDP) have been actively developed as self-luminous flat panel displays (FPDs). With these display panels, the structure in which a light-emitting layer is interposed between an anode layer and a cathode layer is a display element, which acts as a pixel. Since the interface between plurality of thin films constructing the display element and the interface (panel surface) between the panel and the exterior have a critical angle whereby light does not go out to the exterior, among light emitted from the light-emitting layer, light incident on a predetermined layer at an angle larger than the critical angle is confined in the panel, thus not exiting to the exterior. Therefore, among all the amount of light emitted from the light-emitting layer in practice, only a certain ratio of light can be used. With an organic EL device, one of self-luminous devices, it is said that only on the order of 20 to 30 percents of light can be extracted to the exterior of the display panel.

In order to solve the problems of the light-use efficiency or light-extraction efficiency, it has been proposed to provide an inclined surface structure in the panel to reflect or refract light with a radiation angle larger than the critical angle to thereby convert the angle to less than the critical angle, thereby increasing the light-extraction efficiency. For example, JP-A-10-189251 discloses a structure in which a wedge-shaped reflector is arranged around a light-emitting layer to form a reflecting inclined surface structure. With the reflecting inclined surface structure, a predetermined groove is formed in a transparent panel, onto which a metal member is evaporated. Thus a reflecting wedge-shaped member is formed.

### SUMMARY OF THE INVENTION

Display panels are always required to increase the use efficiency or extraction efficiency of light emitted from a light-emitting layer. The employment of the inclined surface structure increases the extraction efficiency of light emitted from the light-emitting layer. However, several tens of percents of light is inevitably absorbed when reflected even by an inclined surface on which a reflector is evaporated. Therefore, a further increase in the use efficiency of all the light from the light-emitting layer may provide a bright image with high contrast. Accordingly, it is still difficult to say that the conventional reflecting inclined surface structure fully uses the light emitted from the light-emitting layer. Furthermore, the employment of the wedge-shaped structure to evaporate the metal, to form the reflecting inclined surface increases the number of production processes as compared with that of a display panel without that structure, thus not being the best in view of production costs and yields.

Accordingly, it is an object of the present invention to provide a display panel capable of further improving higher use-efficiency of light emitted from a light-emitting layer and which can be produced in a short time at low cost and a method of producing the same. It is another object of the invention to provide a high-intensity display apparatus at low cost by using the display panel.

The inclined surface structure is useful in changing the angle of light that is not directed to the emitting direction capable of outgoing through the interface of a transmission layer, such as a transparent panel among light emitted from a light-emitting layer, to direct it in the outgoing direction, and thereby letting it out through the interface. The light-use efficiency, however, does not increase significantly because of absorption during the reflection. Accordingly, the present invention provides an inclined surface structure for totally reflecting emitted light in order to decrease the absorptance of light during reflection. More specifically, a display element according to the invention can include an emission layer having a light-emitting layer for emitting light by a voltage applied between electrodes, a transmission layer for transmitting the light emitted from the light-emitting layer, and a total reflection surface capable of totally reflecting at least a part of the light radiated from the light-emitting layer in the emitting direction of the light from the light-emitting layer.

The reflection by the total reflection surface has no absorption loss as in the reflection by an inclined surface having a reflecting film evaporated thereon, thus increasing light-extraction efficiency. Furthermore, the time and labor of evaporating a reflector can be omitted, thus increasing production efficiency. Accordingly, the application of the invention to a display panel having a plurality of light-emitting layers and a plurality of total reflection surfaces can provide a bright display panel at low cost.

Since transmission layers, which often include a glass or plastic transparent panel, with a high refractive index have a small critical angle on the interface with air, the efficiency of extraction of light emitted or radiated from a light-emitting layer is low. Most of glass substrates have a refraction index of about 1.5, which is not so low that they have a not so high extraction efficiency. In the invention, however, a small critical angle indicates the increase of radiation of the angle range capable of total reflection when an inclined surface for reflecting light that has not been outputted from the interface is made as a total reflection surface. Therefore, having a high refractive index does not always decrease light-extraction efficiency, and thus increases the light-extraction efficiency by using a material suitable for the transmission layer in strength or cost. Furthermore, since there is no need to form an aluminum reflector or the like, the number of man-hours for production is decreased to thereby improve yields. This provides a bright high-contrast display panel at low cost.

Accordingly, the use of the display panel according to the invention and a drive unit for driving the light-emitting layers of the display panel to display an image provides a low-cost display apparatus capable of displaying a high-intensity or bright image.

The total reflection surface can be produced by forming recesses on the side of the transparent member forming the transmission layer facing the emission layer, where in at least one lateral side of each recess acting as the total reflection surface. It may be difficult to form an inclined surface with an angle to totally reflect all light incident on the interface of the transmission layer at an angle larger than the critical angle, depending on the refractive index of the transmission layer. When the angles of light to be reflected are distributed depending on the position of the inclined surface, it is also possible that the portion where the angle is larger than the critical angle is formed as a total reflection surface and the portion where the angle is smaller than the critical angle is coated with a reflector. The interior of the recesses acting as the total reflection surfaces is preferably filled with a material having a lower refractive index than that of the substrate. Although silica aerogel or a fluorocarbon resin may be used as such a material, the recesses are preferably filled with gas such as air or a substantially vacuum condition.

The display panel according to the invention is capable of guiding the light emitted from the light-emitting layers to the transparent member by joining the protrusions between the recesses of the transparent member in the position where they substantially agree with the light-emitting layers with respect to the substrate having the emission layer formed on the surface thereof so as to be brought into optically close contact with the light-emitting layers and also preventing a decrease in the critical angle by an adhesive entering the interior of the recesses. In other words, a decrease in the function of the total reflection surfaces can be prevented even if the protrusions and the light-emitting layers are joined by a bonding layer.

Accordingly, the display panel according to the invention is preferably produced by a method that can include a first step of forming an emission layer on the surface of a substrate, the emission layer including a plurality of light-emitting layers for generating light by a voltage applied between electrodes. The method can also include a second step of forming a transparent panel at the same time or around the first step, the transparent panel acting as a transmission layer for transmitting the light emitted from the light-emitting layers and having a plurality of recesses forming a plurality of total reflection surfaces capable of totally reflecting at least a part of the light radiated from the light-emitting layers in the direction of emission of the light-emitting layers, and a third step of joining the transparent panel and the substrate together in the position that protrusions between the recesses of the transparent panel substantially agree with the light-emitting layers so as to be in optically close contact with the light-emitting layers. This production method provides a high-intensity, high-contrast display panel at low cost without evaporating a reflecting film.

It is also possible to join the substrate having an emission layer formed on the surface and the transparent member by superposing and adhering the substrate and the transparent member with a bonding layer being formed on the surface of the substrate having the emission layer formed. However, in order to prevent the bonding layer from entering the recesses when adhered, the adhesive is preferably applied only to the protrusions of the transparent member. One of the methods of applying the adhesive only to the protrusions is to press the transparent panel against the surface of the transfer table fully coated with the adhesive.

In order to prevent the recesses from being filled with the adhesive, the thickness of the bonding layer is preferably smaller than the depth of the recesses. Furthermore, a display panel having a plurality of light-emitting layers may have the recesses of the transparent member arranged at a different pitch from that of the light-emitting layers. However, when light incident on the interface of the transmission layer at an angle smaller than the critical angle is reflected or refracted, light-use efficiency may be decreased. Therefore, the recesses of the transparent member are preferably arranged at the same pitch as that of the light-emitting layers.

While the inclination angle of the inclined surface acting as a total reflection surface depends on the refracting force of the transmission layer and the radiation distribution of light emitted from the light-emitting layer, it is preferably about 40 degrees to 80 degrees in simulation. Setting the inclination angle of the total reflection surface at about 70 degrees may increase the light-use efficiency.

A circularly polarizing plate is also preferably disposed on the transmission layer adjacent to the emission layer. Providing the circularly polarizing plate prevents extraneous light from entering the display panel and extraneous light reflected by the inclined surface or the back of the light-emitting layer from being outputted to the exterior again to decrease the contrast. Furthermore, according to the invention, since the reflection by the inclined surface is total reflection, the phase difference between the polarized light occurring by one total reflection is on the order of 45 degrees. Accordingly, even if light to be return to the exterior by two times of reflections generates, there is a phase difference of nearly 90 degrees, so that the extraneous light reflection by the two times of reflections can be decreased to about a half even if it cannot be completely eliminated. With the display panel having the inclined surface, it is quite possible for the extraneous light to be reflected outwards (toward the exterior) by the two times of reflection. Therefore, the inclined surface according to the invention that totally reflects light can reduce a decrease in contrast by extraneous light reflection, as compared with the inclined surface having an aluminum reflecting film evaporated thereon in which two times reflections cause twofold phase difference between the polarized light rays to substantially pass the light through the circularly polarizing plate.

The invention can be applied to any display elements or display panels having a self-luminous light-emitting device or a self-luminous device. Therefore, the invention can be applied to display elements or display panels that use a PDP, a light-emitting diode, an inorganic EL device, an organic EL device, and a field emission display. Particularly, it is probably effective to provide an inclined structure to a display element or a display panel having an organic EL device in which the light-emitting layer is an organic-EL light-emitting layer with significantly low light-extraction efficiency, and hence the invention is very useful.

### BRIEF DESCRIPTION OF THE DRAWINGS

The invention will be described with reference to the accompanying drawings, wherein like numerals reference like elements, and wherein:

FIG. 1 is a display apparatus (cellular phone) having a display panel according to an embodiment of the present invention;

FIG. 2 is a schematic plan view of the display panel according to the invention;

FIG. 3 is a schematic sectional view of the display panel of the embodiment;

FIG. 4 is a sectional view of the details of an emission layer of the display panel of the embodiment;

FIG. 5 is a diagram showing the state in which part of light radiated from a light-emitting layer is reflected by an inclined surface;

FIG. 6 is a diagram comparing the light-extraction efficiency of a display panel that reflects light by a total reflection surface with that of a display panel that reflects hundred-percent light by an inclined surface according to an angle of inclination;

FIG. 7 is a diagram showing a method for producing a display panel;

FIG. 8 is a diagram showing the state of joining a substrate having an emission layer to a transparent member;

FIG. 9 is a diagram for explaining the principle of reducing extraneous-light reflection with a circularly polarizing plate;

FIG. 10 is a schematic sectional view of another display panel;

FIG. 11 is a diagram of the display panel of FIG. 10, showing the state of joining a substrate having an emission layer to a transparent member; and

FIG. 12 is a diagram showing the state in which an adhesive has entered recesses.

### DETAILED DESCRIPTION OF PREFERRED EMBODIMENTS

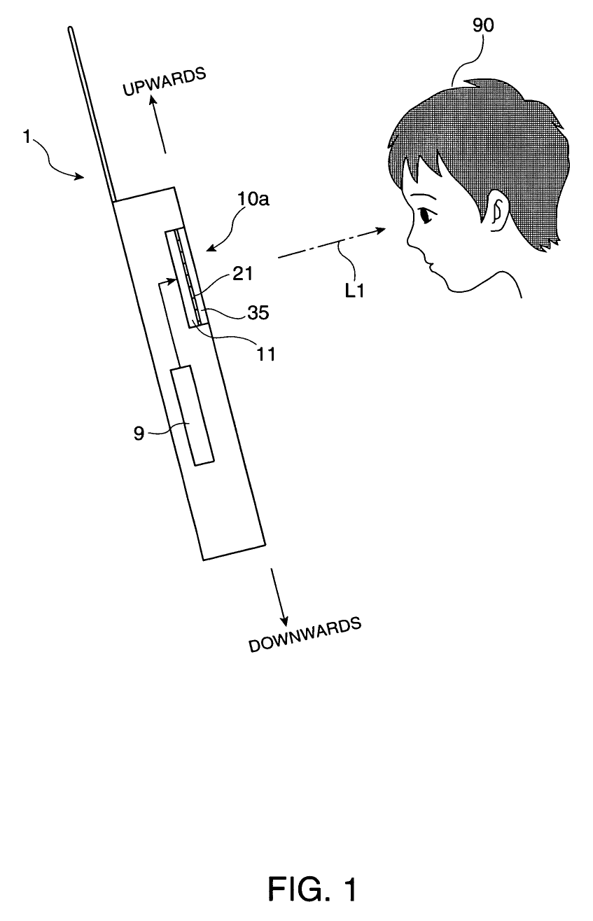

The present invention will be specifically described hereinafter with reference to the drawings. FIG. 1 shows a cellular phone as a display apparatus having a display panel according to an embodiment of the present invention. A cellular phone 1 of this embodiment can include a display panel having an organic EL device that is a self-luminous device as a display panel 10a that displays data, on which data including characters and images is viewed by a user 90 such that the organic EL device emits light L1 by a drive unit 9 complying a microcomputer or the like.

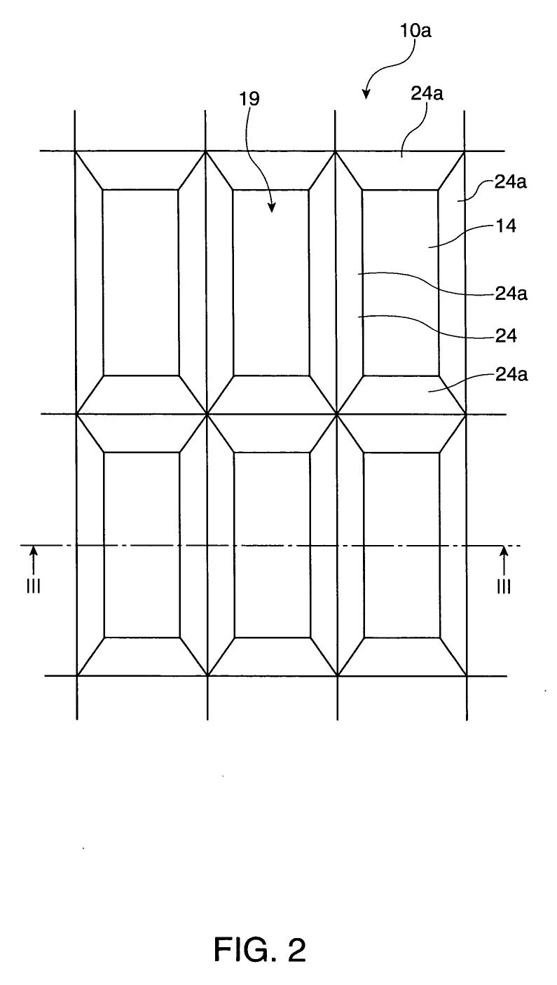

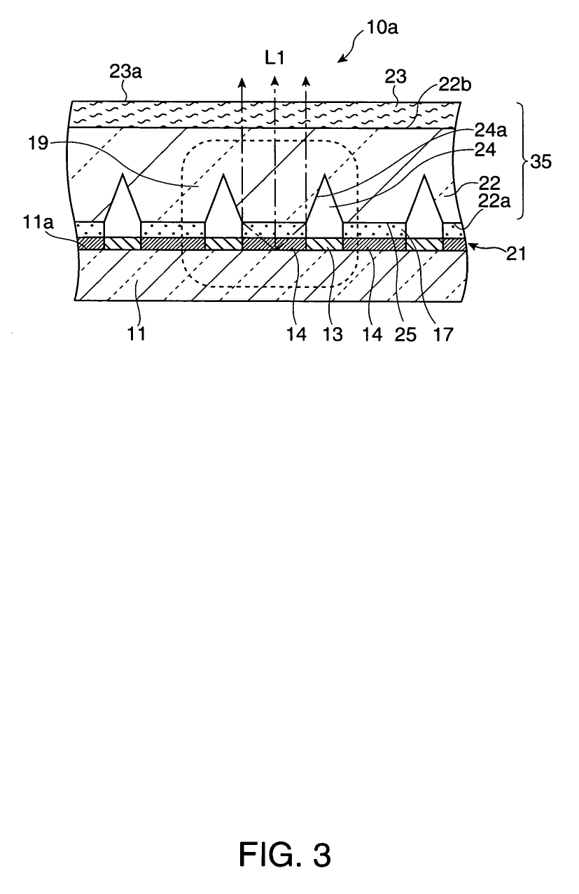

FIG. 2 shows part of the display panel in enlarged plan view. FIG. 3 shows the display panel of FIG. 2, taken along line III-III in section. The display panel 10a of this embodiment has a plurality of display elements 19 disposed in an array or matrix form in two dimensions, each of the display elements 19 with an organic electro-luminescent (organic EL) device as a light-emitting layer functioning as one pixel. The display panel 10a can be activated by an active matrix or passive matrix system. The display elements 19 are each arranged between electrodes and include an emission layer 21 having a light-emitting layer 14 that emits light by the application of voltage between the electrodes, and a transmission layer 35 deposited on the emission layer 21 for transmitting the light L1 emitted from the light-emitting layer 14. The display device 19 totally reflects part of the light emitted or radiated from the light-emitting layer 14 by total reflection surfaces 24a formed on the transmission layer 35 to convert its emergence angle.

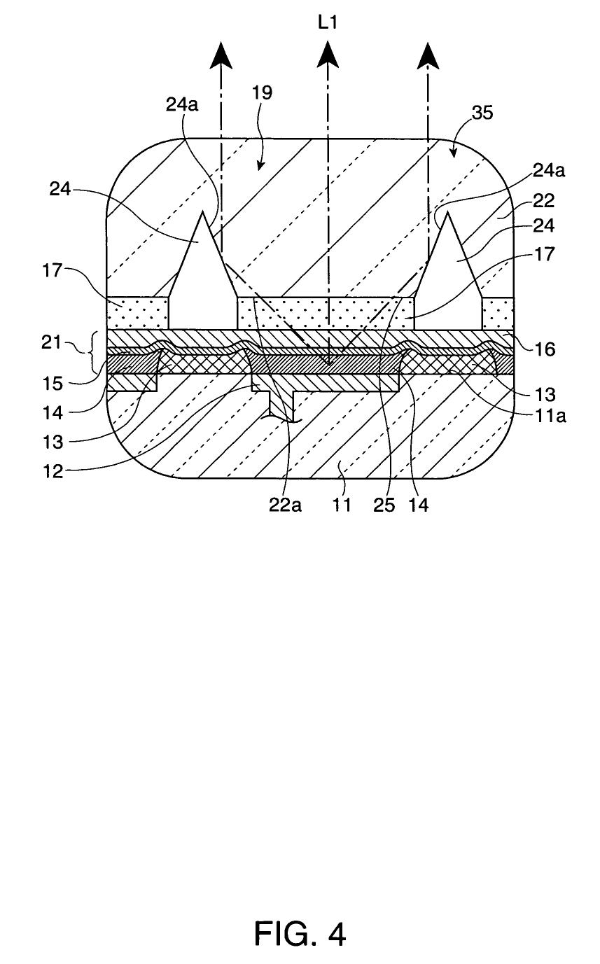

FIG. 4 shows the details of the display element 19. The emission layer 21 is a layer deposited on a substrate 11 serving as a base, such as a glass substrate. Firstly, an anode layer 12 made of indium tin oxide (ITO) is selectively formed on the upper surface 11a of the glass substrate 11, and further, a polyimide bank layer 13 is formed on the position out of the anode layer 12. An organic EL light-emitting layer 14 is deposited on the upper surface of the anode layer 12, or the area surrounded by the bank layer 13.

The light-emitting layer 14 can be produced by an inkjet technique, in which the bank layer 13 is used for alignment when the light-emitting layer 14 is deposited. The light-emitting layer 14 of this embodiment may be made as a single layer of organic EL. Alternatively, it may be a layer having a hole transport layer or an electron transport layer in order to improve light-emitting efficiency.

An ITO cathode layer 15 can be formed on the bank layer 13 and the light-emitting layer 14. The application of voltage to the anode layer 12 and the cathode layer 15 causes the light-emitting layer 14 placed therebetween to emit light spontaneously. A protective layer 16 made of silicon oxide (SiO₂) is deposited on the top of the cathode layer 15.

A transmission layer 35 of this embodiment is formed of a transparent polycarbonate sheet 22 of about 0.5 mm in thickness. The back 22a of the sheet 22 has V-shaped grooves (recesses) 24 of 30 to 70 μm in depth, thereby the back 22a is formed with irregularity. It should be understood that each recess 24 is not limited to the V-shaped groove but may be trapezoidal. It is enough that there are formed recesses whose lateral sides 24a located at the both sides of the light-emitting layer 14 are inclined. The transmission layer 35 is deposited on the top surface of the protective layer 16 via a bonding layer (adhesive) 17 of about 3 μm in thickness such that a protrusion 25 between the recesses 24 is superposed on the light-emitting layer 14 via the protective layer 16. The adhesive 17 is coated only on the protrusion 25 to bring the protrusion 25 into optically close contact with the light-emitting layer 14. Accordingly, light emitted from the light-emitting layer 14 is incident on the transmission layer 35 through the adhesive 17 and is outputted through the transmission layer 35. The adhesive 17 may be a thermosetting resin such as an epoxy resin or an ultraviolet curing resin. The use of the ultraviolet curing resin, however, may damage the EL layer (light-emitting layer) 14 by ultraviolet rays that are radiated during the curing of the resin. Therefore, it is desirable to select the adhesive 17 in consideration of the effects to the EL layer.

Also, since the adhesive 17 is applied only to the protrusion 25 of the transmission layer 35, the recesses 24 in the transmission layer 35 are filled not with the adhesive 17, but with air. The recesses 24 may be filled with gas other than air by appropriately packaging the display panel 10a and may also be evacuated by decompression. The transmission layer 35 also has a circularly polarizing layer 23 (refer to FIG. 3) on the front surface (interface) 22b thereof that has a polarizing plate and a retardation plate for reducing extraneous light reflection. With this embodiment, the transmission layer 35 includes also a transparent member 22 and the circularly polarizing layer 23. Of course, the circularly polarizing layer 23 may be omitted from the transmission layer 35.

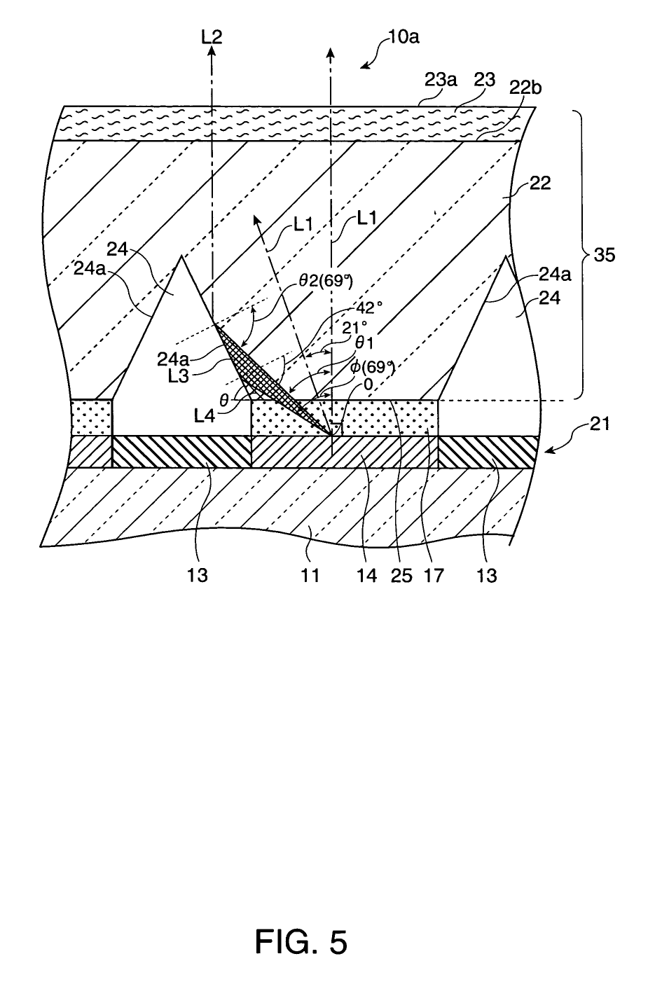

FIG. 5 shows the state in which the light emitted or radiated from the light-emitting layer 14 exits. The transparent member 22 (transmission layer 35) of this embodiment is made of polycarbonate whose refractive index n is about 1.5, in which the interior of the recesses 24 is filled with gas or substantially evacuated. Specifically, the inclined surfaces 24a are surfaces where an area (an air area surrounded by the recesses 24) having a refractive index lower than that of the transparent member 22 and the transparent member 22 (transmission layer 35) are in contact with each other. Consequently, light incident on the inclined surfaces (lateral surfaces) 24a at an incidence angle larger than a critical angle θ1 is totally reflected by the inclined surfaces 24a. The critical angle θ1 (θ1=arcsin (1/n)) of the transparent member 22 is approximately 42 degrees. The material of the circularly polarizing layer 23 is selected so that its refractive index is the same as that of the transparent member 22 (transmission layer 35). Therefore, in this embodiment, the refraction index of the circularly polarizing layer 23 is about 1.5. Accordingly, the light incident on the front surface 22b is not totally reflected. On the other hand, an interface 23a of the circularly polarizing layer 23 is in contact with an air layer. Therefore, for the light outgoing from the circularly polarizing layer 23 to the exterior, the critical angle of the interface 23a is the same as the critical angle θ1 of the inclined surfaces (lateral surfaces) 24a.

The light emitted from the light-emitting layer 14 radiates substantially in a manner similar to light emitted from a point source. Accordingly, the light L1 emitted from the light-emitting layer 14 to the transparent member 22 such that the incidence angle relative to the interface 23a is lower than the critical angle is outputted, without any change through the interface 23a to the exterior. In contrast to the outgoing light L1, among diverging light L2 incident on the inclined surface 24a in the transparent member 22, the light L2 incident on the inclined surfaces 24a at an angle larger than the critical angle θ1 is totally reflected by the inclined surface 24a in the outgoing direction of the light L1 and outputted from the transparent member 22 to the exterior.

When the inclination angle θ of the inclined surfaces 24a is set at, for example, about 70 degrees, among light with its light-emitting point at the center O of the light-emitting layer 14, the light L2 incident on the interface 23a of the transmission layer 35 at the critical angle θ1 can be reflected substantially perpendicular to the interface 23a (at an incidence angle of 0), so that the light L2 can be outputted to the exterior. The incidence angle θ2 of the light L2 relative to the inclined surface 24a is about 69 degrees, which is sufficiently larger than the critical angle θ1 (about 42 degrees) of the transparent member 22 with the refraction index n of 1.5, so that it is totally reflected by the inclined surface 24a. Light L3 in the range that is emitted at an angle larger than that of the light L2 and incident on the inclined surface 24a at the critical angle θ1 or more (the surrounded area of FIG. 5) is totally reflected by the inclined surface 24a and outputted to the interface 23a at an angle smaller than the critical angle θ1. Therefore, the light, to be totally reflected by the interface 23a without the inclined surface 24a, is totally reflected by the inclined surface 24a to change the optical path, and outputted from the interface 23a.

With the display panel 10a of the embodiment, light L4 in the range in which it is incident on the inclined surface 24a at the critical angle θ1 or less (the surrounded area of FIG. 5) passes through the inclined surface 24a, thus not being reflected. However, the light L3 that is incident on the inclined surface 24a at an angle larger than the critical angle θ1 has nearly hundred-percent reflectance in contrast to the case of an aluminum reflecting material having a reflectance as low as several tens of percents because of absorption loss. Therefore, even when the light L4 in the range in which it is incident on the inclined surface 24a at the critical angle θ1 or less has transmitted, light-extraction efficiency equal to or higher than that of a conventional inclined structure can be provided. Furthermore, growing a reflector in the area on which the light L4 in the range in which it is incident on the inclined surface 24a at the critical angle θ1 or less allows light in the range to be extracted.

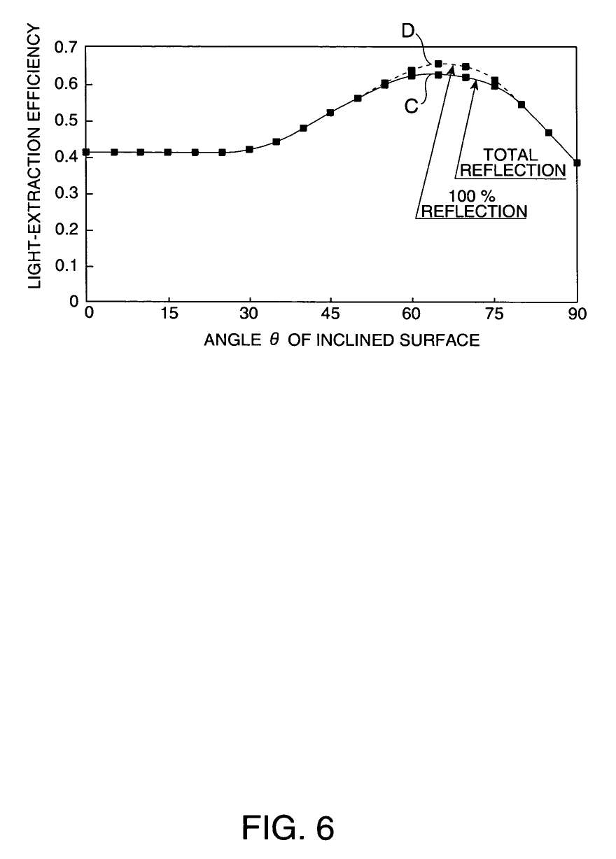

FIG. 6 shows the relationship between the light efficiency (light-extract efficiency) extracted form the display panel 10a and the angle of the inclined surface 24a. Curve C in the drawing indicates the light-extraction efficiency of the display panel 10a when the light is totally reflected by the inclined surface 24a. Curve D indicates the light-extraction efficiency of the display panel 10a when the inclined surface 24a has a reflecting film. The curve D is plotted assuming an ideal reflecting film with hundred-percent reflectance. FIG. 6 shows the measurement for the light-emitting layer 14 (pixel) with dimensions of 190 μm×50 μm in plane and with the recess 24 of 40 μm in width surrounding the light-emitting layer 14. The refractive index of the transparent member 22 is approximately 1.52.

As is apparent from FIG. 6, the total reflection by the inclined surface 24a provides almost the same light-extraction efficiency, except a part, as that of reflection by the reflecting film on the inclined surface 24a. With the conventional structure in which a reflecting film is deposited, since the reflectance of aluminum is on the order of 90 percent or less in practice, the reflectance in all angle areas is ten percents or more lower than the curve D. Accordingly, the present invention provides high reflectance in all angle areas in contrast to that of the conventional structure with a reflecting inclined surface, thus increasing light-use efficiency.

As can be seen in FIG. 6, it is in the range where the inclination angle θ of the inclined surface is on the order of 40 to 80 degrees that the light-extraction efficiency can be increased, where a light-extraction efficiency of 0.4 or more can be provided as compared with substantially less than 0.4 for the other angle ranges. The highest efficiency can be provided at an inclination angle θ of the order of 70 degrees, with extraction efficiency as high as substantially 0.6 or more being provided. This may be theoretically because, assuming that the inclination angle θ is 69 degrees, among the radiation distribution of light emitted from the light-emitting layer 14, light in which the radiation angle φ on one side is within 69 degrees can be totally reflected by the inclined surface 24a to be outputted from the transparent member 22, so that almost all the light emitted from the light-emitting layer 14 at principal angles can be aligned to the direction to exit from the transparent member 22.

As described above, the display panel 10a of the embodiment totally reflects part of the light radiated from the light-emitting layer 14 not by an inclined surface with an evaporated reflecting film but by the lateral sides of the recesses 24 formed in the transparent member 22 that is the transmission layer 35 to change the optical path, thereby preventing absorption loss by the reflecting film. Conventionally, the transparent panel or transparent member 22 with a high refractive index is so difficult to extract light that it is hard to use. According to the invention, however, the critical angle on the inclined surface can be small, so that the reflection efficiency of the inclined surface can be increased, thus having less decrease in the light-use efficiency, which increases the availability of a high-refraction material as the transmission layer 35 of a self-luminous display panel. Accordingly, a high-intensity or bright display panel can be produced or provided by using the transparent panel or transparent member 22 with high refraction index as large as 1.5. Moreover, there is no need to deposit a reflecting film, thus providing a high-yield low-production-cost display panel. Thus, a low-cost display apparatus 1 capable of displaying a bright image can be provided by using the high-intensity low-cost display panel 10a according to the invention.

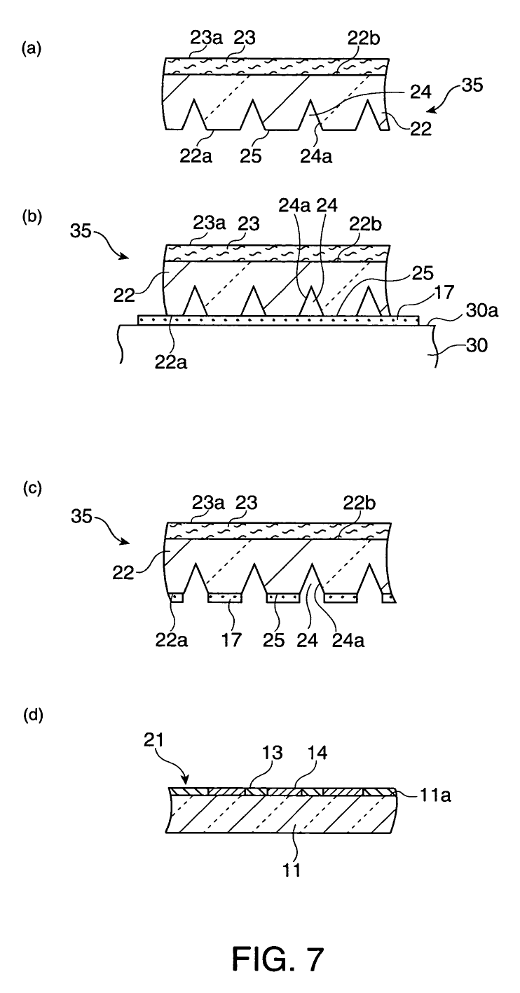

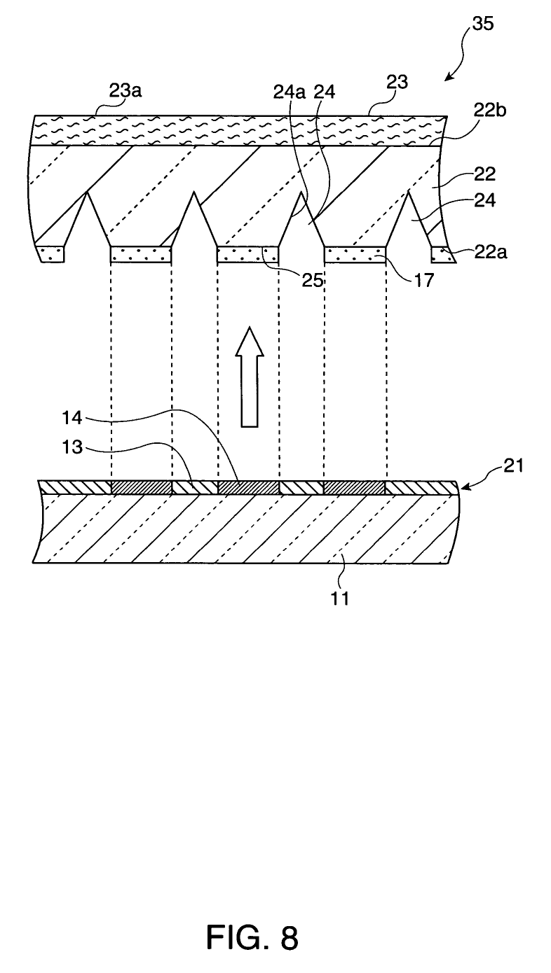

FIG. 7 and FIG. 8 show a method for producing the display panel 10a. As FIG. 7(a) shows, the V-shaped grooves (recesses) 24 of 30 μm to 70 μm in depth are formed in the surface 22a of a polycarbonate member (transparent member) of approximately 0.5 mm in thickness (corresponding to the aforesaid second process). As described above, the inclination of the lateral sides or inclined surfaces 24a of each recess 24 are preferably set at the order of 70 degrees. About the time the recesses 24 are formed, or after the transparent member 22 and the substrate 11 having the emission layer 21 has been joined together, as will be described in greater detail below, the circularly polarizing plate 23 is bonded to the front surface 22b of the transparent member 22.

As FIG. 7(b) shows, the transparent member 22 is pressed against the surface 30 of a transfer table 30, on which the adhesive 17 is transferred so that the irregular surface 22a is brought into close contact therewith (corresponding to the aforementioned applying step). Thus, as FIG. 7(c) shows, when the transparent member 22 is separated from the transfer table 30, the adhesive 17 is applied only to the protrusions 25 of the transparent member 22. At that time, the adhesive 17 with a thickness of a half of that transferred to the front surface 30a of the transfer table 30 is transferred to the protrusions 25, depending on the type of the adhesive 17.

As FIG. 7(d) shows, the emission layer 21 including the light-emitting layer 14 is formed on the substrate 11 around the time the above mentioned transparent member 22 is prepared or at a proper timing (corresponding to the aforesaid first step). As FIG. 8 shows, the transparent member 22 and the substrate 11 are brought into close contact with each other so that the protrusions 25 of the transparent member 22 are superposed on the light-emitting layers 14, and the adhesive 17 is cured by heat or ultraviolet rays to produce the display panel 10a having the emission layer 21 held between the transparent member 22 and the substrate 11. As described above, the display panel 10a according to the invention does not need to form a reflecting film on the inclined surface during producing, thus allowing the process of forming a film, such as deposition, to be omitted, so that it can be produced in a short time at low cost.

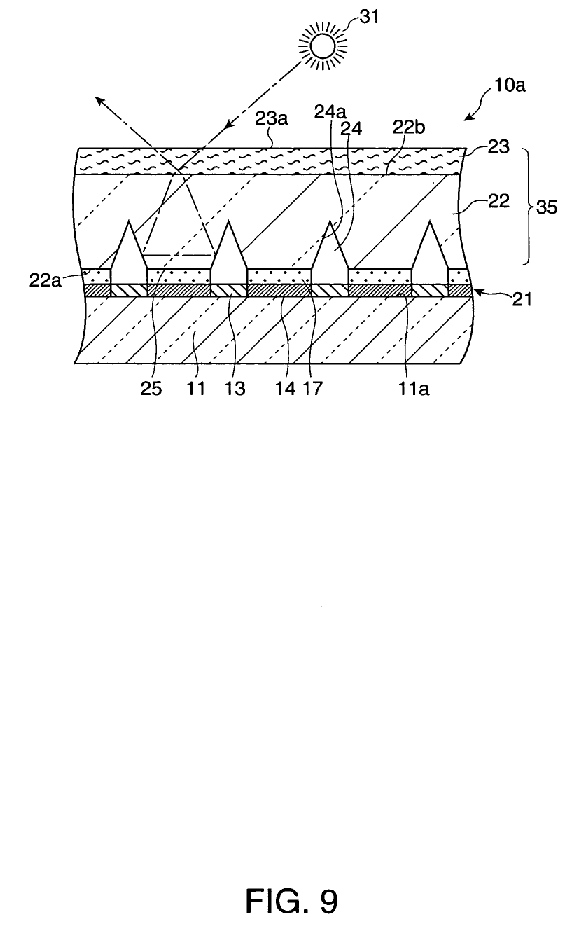

The display panel 10a of the embodiment has the circularly polarizing plate 23 on the front surface 22b of the transparent member 22, thus preventing a decrease in contrast due to extraneous-light reflection. However, as FIG. 9 shows, when two times of reflections occur, the circularly polarizing plate 23 may not prevent the extraneous-light reflection. Specifically, with the display panel 10a having the recesses 24, when extraneous light 31 incident on the display panel 10a is once reflected horizontally by the inclined surface 24a and again reflected by the opposing inclined surface 24a, it may be outputted through the front surface 22b of the transparent member 22 to the exterior. Forming a reflecting film on the inclined surface causes the extraneous light 31 to generate twice as much phase difference due to two times of reflections by the inclined surface 24, passing most of the extraneous light 31 through the circularly polarizing plate 23, which causes a decrease in contrast.

However, although the display panel 10a of the embodiment has the inclined surface or the recess, the inclined surface 24a is a total reflection surface. Therefore, extraneous light that strikes the inclined surface 24a at an angle smaller than the critical angle is not reflected by the inclined surface 24a. Extraneous light to be reflected twice and having an angle such that outputted from the transparent member 22 to the exterior transmits horizontally in the transparent member 22, as shown in FIG. 9, most of which is incident on the inclined surface 24a at an angle smaller than the critical angle and hence has a low possibility to be reflected twice. Therefore, there is a low possibility for the extraneous light to be reflected by the inclined surface 24a a number of times to be outputted to the exterior again. Accordingly, the employment of the total-reflection inclined surface 24a with the light-absorption back of the light-emitting layer 14 will reduce substantial influence of the extraneous light even with the display panel 10a without the circularly polarizing plate 23.

Assuming that two times of reflections occur, the phase difference in a total reflection surface caused by one reflection is about 45 degrees, so that two times of reflections cause a phase difference of about 90 degrees. Therefore, providing the circularly polarizing plate 23 causes about half of light incident on the circularly polarizing plate 23 by two times of reflections to pass through the circularly polarizing plate 23, while the remaining half not to pass through the circularly polarizing plate 23. Thus, the amount of extraneous light to be outputted to the exterior can be reduced, so that a decrease in contract can be reduced. In other words, the display panel 10a according to the embodiment changes the path of light emitted from the light-emitting layer 14 with the total-reflection inclined surface 24a; accordingly, the extraneous-light reflection can be reduced to maintain the decrease in contrast at low level merely by providing the circularly polarizing plate 23.

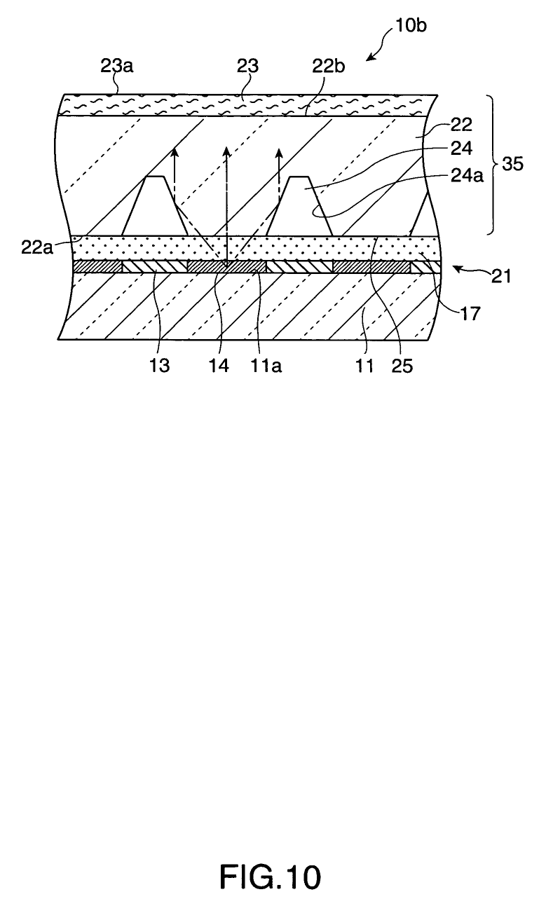

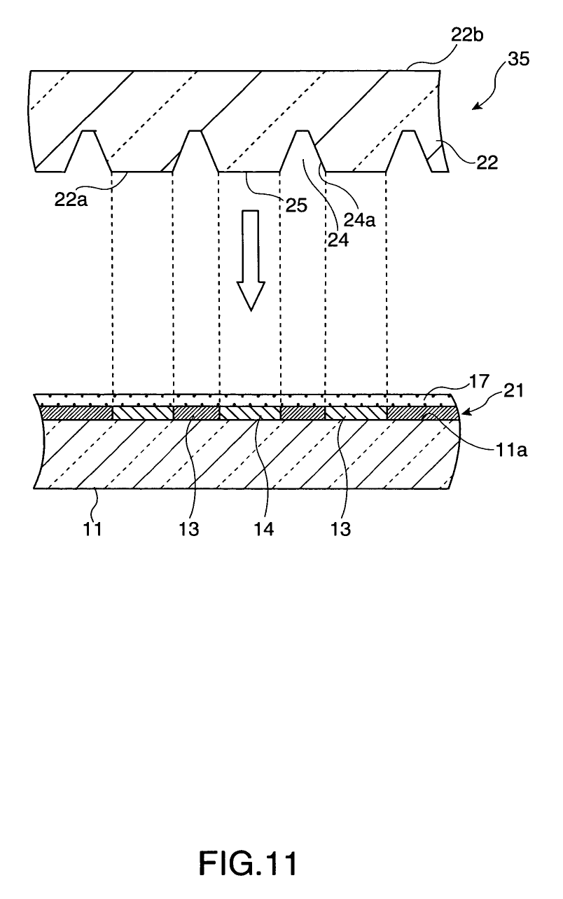

FIG. 10 shows another display panel 10b schematically in section, and FIG. 11 shows the state of joining the substrate 11 having the emission layer 21 to the transparent member 22. The display panel 10b of this embodiment is formed such that the substrate 11 having the emission layer 21 is coated with the adhesive 17 made of a transparent thermosetting resin with a thickness of 3 μm by spin coating to join the substrate 11 to the transparent member 22. Specifically, the substrate 11 and the transparent member 22 are aligned with a register mark and brought into contact with each other in a decompressed atmosphere, which are finely adjusted as necessary and joined together under pressure and heat. Also with the display panel 10b, the lateral sides 24a of the recess 24 act as total reflection surfaces, thus increasing the light-extraction efficiency and simplifying the production process.

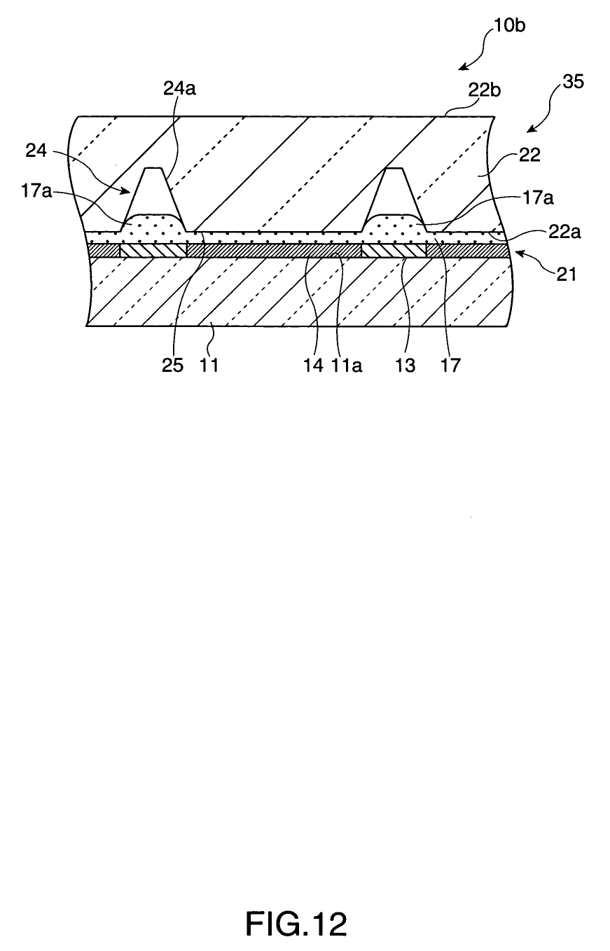

In the method in which the adhesive 17 is applied on one surface of the substrate 11, however, when the adhesive 17 is thick, the recesses 24 may be filled with the adhesive 17. Entering of the adhesive 17 into the recesses 24 may soil the inclined surfaces 24a to change the conditions to totally reflect the light outputted from the light-emitting layer 14. Therefore, as FIG. 12 shows, an adhesive 17a that can enter the recesses 24 is desirably reduced.

For this purpose, it is preferably to decrease the adhesive 17 in thickness by spin coating, thus making the inclined surfaces 24a of the recess 24 to function as total reflection surfaces dependably.

Although the above embodiment has a structure in which the recesses 24 are arranged at the same pitch as that of the light-emitting layers (pixels) 14, the display panel may have formed with another pitch of the recesses 24, which is not limited to the above pitch. Providing the recesses 24 in front of the light-emitting layers 14 may refract or totally reflect the light emitted from the light-emitting layers 14 in the emitting direction on the inclined surfaces to reduce the light-extraction efficiency. Therefore, like the aforesaid display panels 10a and 10b, the pitch of the light-emitting layers 14 serving as pixels and that of the recesses of the transparent panel are preferably in good agreement with one another.

While the display panel of the invention has been described with a display panel mounted to a cellular phone as an example, it should be under stood that the invention can also be applied to compact display panels mounted to personal digital assistants (PDAs) and large-sized 30-inch display panels and so on that are now being developed actively. Although a light-emitting layer having an organic EL device has been described, the invention can also be applied to any display panels having a light-emitting layer that emits light spontaneously by the application of voltage between electrodes, such as a PDP, a light-emitting diode, an inorganic EL device, an organic EL device, and a field emission display.

As described above, according to the invention, part of light radiated by the light-emitting layer is reflected not by depositing reflecting film but by a total reflection surface. This allows reflection loss to be eliminated, thus providing high light-extraction efficiency. Also, there is no need to deposit a reflecting film, thus facilitating the production. Accordingly, an increase in the light-extraction efficiency and a decrease in the cost of production can be achieved at the same time, thus providing a low-cost display element, a display panel, and a display apparatus which are capable of displaying a high-intensity or bright image.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. A display element, comprising:
an emission layer having a light-emitting layer that emits light by a voltage applied between electrodes;
a transmission layer that transmits the light emitted from the light-emitting layer; and
a total reflection surface in the transmission layer, that is capable of totally reflecting at least a part of the light radiated from the light-emitting layer in a direction of emission of the light-emitting layer.

2. The display element according to claim 1, the transmission layer including a transparent member, the side of the transparent member facing the emission layer having recesses, at least one lateral side of each recess acting as the total reflection surface.

3. The display element according to claim 2, the interior of the recess being filled with gas or substantially evacuated.

4. The display element according to claim 2, comprising a substrate having the emission layer on the surface thereof,
the transparent member being joined to the substrate in a position that a protrusion between the recesses of the transparent member substantially correspond to the light-emitting layer so as to be in optically close contact with the light-emitting layer.

5. The display element according to claim 2, further comprising:
a substrate having the emission layer on the surface thereof; and
a bonding layer that is formed between the transparent member and the emission layer so that a protrusion between the recesses of the transparent member is in optically close contact with the light-emitting layer.

6. The display element according to claim 5, the thickness of the bonding layer being smaller than a depth of the recesses.

7. The display element according to claim 2, comprising a plurality of the light-emitting layers, protrusions between the recesses being arranged at a same pitch as that of the light-emitting layers.

8. The display element according to claim 1, the inclination angle of the total reflection surface being approximately from 40 degrees to 80 degrees.

9. The display element according to claim 1, the inclination angle of the total reflection surface being approximately 70 degrees.

10. The display element according to claim 1, further comprising a circularly polarizing plate that is disposed on the transmission layer adjacent to an emerging surface.

11. The display element according to claim 1, the light-emitting layer being an organic-electro-luminescence light-emitting layer.

12. A display panel, comprising:
an emission layer having a plurality of light-emitting layers that emits light by a voltage applied between electrodes;
a transmission layer that transmits light emitted from the light-emitting layers; and
a plurality of total reflection surfaces in the transmission layer, that is capable of totally reflecting at least a part of the light radiated from the light-emitting layers in a direction of emission of the light-emitting layers.

13. The display panel according to claim 12, comprising a transmission panel acting as a transmission layer, a side of the transparent panel facing the emission layer having a plurality of recesses, at least one lateral side of which acting as total reflection surfaces.

14. The display panel according to claim 13, protrusions between the recesses being arranged at a same pitch as that of the light-emitting layers.

15. A display apparatus, comprising the display panel according to claim 12 and a drive unit that drives the light-emitting layers of the display panel to display an image.

16. A method for producing a display panel, comprising:
forming an emission layer on a surface of a substrate, the emission layer including a plurality of light-emitting layers that generate light by a voltage applied between electrodes;
forming a transparent panel at a same time or around thereto, the transparent panel acting as a transmission layer that transmits the light emitted from the light-emitting layers and having a plurality of recesses forming a plurality of total reflection surfaces capable of totally reflecting at least a part of the light radiated from the light-emitting layers in the direction of emission of the light-emitting layers; and
joining the transparent panel and the substrate together in the position that protrusions between the recesses of the transparent panel substantially corresponds to the light-emitting layers so as to be in optically close contact with the light-emitting layers.

17. The method for producing a display panel, according to claim 16, further comprising applying an adhesive only to the protrusions of the transparent panel before joining the transparent panel and substrate together.

18. The method for producing a display panel, according to claim 17, in the step of applying the adhesive, the transparent panel being pressed against the surface of a transfer table fully coated with the adhesive.
